(19) United States
(12) Patent Application Publication
(10) Pub. No.: US 2025/0014846 A1
(43) Pub. Date: Jan. 9, 2025

(54) TRIGGER SWITCH AND DEVICE INCLUDING THE TRIGGER SWITCH

(71) Applicant: OMRON Corporation, KYOTO (JP)

(72) Inventors: Kohei SUGIYAMA, Kyoto-shi (JP); Kazushi MAETA, Kyoto-shi (JP); Yohei TSUKANAKA, Kyoto-shi (JP); Akihiro ISHII, Kyoto-shi (JP); Daiki ANDO, Kyoto-shi (JP); Takumi FUJIHARA, Kyoto-shi (JP)

(73) Assignee: OMRON Corporation, KYOTO (JP)

(21) Appl. No.: 18/735,222

(22) Filed: Jun. 6, 2024

(30) Foreign Application Priority Data
Jul. 6, 2023 (JP) 2023-111096

(51) Int. Cl. H01H 13/62; B25F 5/00; H01H 9/20

(52) U.S. Cl. CPC H01H 13/62; H01H 9/20; B25F 5/00

(57) ABSTRACT

A trigger switch capable of suppressing wear of a sliding electrode part and a device including the trigger switch are provided. A trigger switch includes a front sub-brush and a rear sub-brush that, when a drive part is driven by a movement of a trigger caused by a push-in operation to the trigger, move from an on-position where they contact a front sub-electrode and a rear sub-electrode on a substrate to an off-position where they do not contact the front sub-electrode and the rear sub-electrode. As the front sub-brush and the rear sub-brush move from the on-position to the off-position, a contact between the front sub-brush and the rear sub-brush and the substrate are released.

### CROSS-REFERENCE TO RELATED APPLICATIONS

The disclosure claims the priority benefits of Japanese application no. 2023-111096, filed on Jul. 6, 2023. The entity of the above-mentioned patent application is hereby incorporated by reference herein and made a part of this specification.

### BACKGROUND

### Technical Field

The disclosure relates to a trigger switch that drives a drive part of a device by movement of a trigger caused by a push-in operation to the trigger, and to a device including the trigger switch.

### Related Art

For example, a trigger switch used to control a device such as an electric tool includes: a trigger which receives a push-in operation; a shaft member which supports the trigger on one end side; a housing having a through hole through which the other end side of the shaft member passes; and a switching mechanism (a switching mechanism including a brush which constitutes a sliding contact of a circuit) which is accommodated in the housing and is connected to the other end side of the shaft member. In a trigger switch configured in this way, the shaft member moves toward the inside of the housing by a push-in operation to the trigger, and in accordance with the movement, the switching mechanism moves inside the housing, switching the sliding contact ON and OFF, thereby driving the drive part. Moreover, the shaft member moves toward the outside of the housing when the trigger is released from the push-in operation. Along with the movement, the switching mechanism moves inside the housing (moving in the opposite direction to the push-in operation), switching the sliding contact ON/OFF (switching in the opposite direction to the push-in operation), thereby stopping the drive part.

Patent document 1 discloses a trigger switch in which a switching mechanism (referred to as a plunger in the patent document 1) includes a brush that constitutes a sliding contact having an ON/OFF switching function for the drive part, and a brush that constitutes a sliding contact that adjusts the output of the drive part.

### CITATION LIST

### Patent Document

[Patent Document 1] Japanese Patent Laid-open No. JP 2020-30999 A

A sliding contact disclosed in Patent Document 1 is composed of an electrode formed on a substrate and a brush which is a sliding electrode part provided on a switching mechanism, and by moving the switching mechanism, the brush may be switched between a state in which it contacts the electrode (a state in which it moves to a position where it contacts the electrode) and a state in which it does not contact the electrode (a state in which it moves to a position where it does not contact the electrode). Moreover, when the brush is not in contact with the electrode, the brush is in contact with the surface of the substrate (the surface of the substrate on which no electrode is formed, hereinafter referred to as the resin surface).

For example, in a case where the sliding contact for activating a microcomputer on the substrate is an NC (normally closed) contact, the drive part is driven while the brush of the sliding contact is maintained in contact with the resin surface. For this reason, there is a concern that vibrations due to the driving of the drive part will be transmitted to the brush and the substrate, and the brush will be worn down due to sliding between the brush and the resin surface. When the brush is worn (particularly when the contact part of the brush contacting the electrode is worn), the contact reliability when the contact part of the brush contacts the electrode may deteriorate. Moreover, such a problem arises not only in a configuration in which an electrode (fixed electrode) is provided on a substrate, but also in a case in which an electrode is fixed by other fixing structures.

The disclosure has been made in consideration of the above-mentioned points, and an object of the disclosure is to provide a trigger switch capable of suppressing wear of the sliding electrode part, and a device including the trigger switch.

### SUMMARY

The disclosure provides a trigger switch including a sliding electrode part that, when a drive part is driven by a movement of the trigger caused by a push-in operation to the trigger, moves from an on-position where it contacts a fixed electrode to an off-position where it does not contact the electrode. As the sliding electrode part moves from the on-position to the off-position, a contact between the sliding electrode part and a fixing member that fixes the electrode is released.

Moreover, a device including the trigger switch is also within the scope of the technical idea described in the disclosure. In other words, the drive part is driven in a state where the contact between the sliding electrode part and the fixing member is released.

### BRIEF DESCRIPTION OF THE DRAWINGS

FIG. 1 is a schematic perspective view showing an example of the appearance of an electric device according to the disclosure.

FIG. 2 is a schematic perspective view showing an example of the appearance of the trigger switch according to the disclosure.

FIG. 3 is a schematic side view showing an example of the inside of a housing of the trigger switch according to the disclosure.

FIG. 4 is a schematic side view showing an example of a released state of the trigger switch according to the disclosure.

FIG. 5 is a schematic perspective view showing an example of a released state of the trigger switch according to the disclosure.

FIG. 6 is a cross-sectional view taken along line VI-VI in FIG. 4.

FIG. 7 is a schematic block diagram showing an example of a part of a control configuration of the electric device according to the disclosure.

FIG. 8 is a schematic side view showing an example when a push-in operation is performed to a trigger of a trigger switch according to the disclosure.

FIG. 9 is a schematic perspective view showing an example when a push-in operation is performed to a trigger of a trigger switch according to the disclosure.

FIG. 10 is a cross-sectional view taken along line X-X in FIG. 8.

FIG. 11 is a time chart showing an example of changes in a sub-sliding contact and the signal of the switching part, the state of the microcomputer, and the device rotation speed when a push-in operation is performed to the trigger in the electric device according to the disclosure.

FIG. 12 is a schematic view showing a contact state between a sub-brush and a sub-electrode when the trigger switch is in a released state in a modified example of the trigger switch according to the disclosure.

### DESCRIPTION OF THE EMBODIMENTS

The disclosure provides a trigger switch including a sliding electrode part that, when a drive part is driven by a movement of the trigger caused by a push-in operation to the trigger, moves from an on-position where it contacts a fixed electrode to an off-position where it does not contact the electrode. As the sliding electrode part moves from the on-position to the off-position, a contact between the sliding electrode part and a fixing member that fixes the electrode is released.

Moreover, an example of the sliding electrode part referred to here includes a brush capable of contacting the electrode on the fixing member. The fixing member referred to here includes a substrate and other members for fixing the electrodes.

Moreover, it is provided with a switching circuit that transitions from an off-state to an on-state as the push-in operation to the trigger progresses so as to drive the drive part. At a stage before the switching circuit transitions from the off-state to the on-state as the push-in operation progresses, the contact between the sliding electrode part and the fixing member is released.

As the sliding electrode part moves from the on-position to the off-position, it is deformed in a direction away from the electrode, releasing the contact with the fixing member.

Moreover, it is provided with a posture restricting part that, in a state where the sliding electrode part is in the on-position, restricts the sliding electrode part to a posture elastically deformed in a direction of contacting the electrode. When the sliding electrode part is in the off-position, restriction of the posture by the posture restricting part is released and the sliding electrode part restores its shape from the elastically deformed posture, releasing the contact with the fixing member.

Moreover, it is provided with a moving member that is movable between a push-in position and a push-in release position in accordance with the push-in operation to the trigger and a release of the push-in operation; and an elastic plate part configured such that it receives an external force from the moving member in a state where the moving member is in the push-in release position and assumes an elastically deformed posture, and restores its shape from the posture elastically deformed by the external force due to the external force being released by the moving member moving from the push-in release position toward the push-in position. In a state where the elastic plate part assumes the elastically deformed posture, the sliding electrode part is in an on-position where it contacts the electrode by being restricted in posture by the posture restricting part. In a state where the elastic plate part has restored its shape, the restriction of the posture by the posture restricting part is released and the contact with the fixing member is released.

Moreover, an example of the moving member referred to here includes a drive switching mechanism including a part of the switching circuit.

Moreover, in the fixing member, an opening is formed in a region facing the sliding electrode part in the off-position.

Moreover, a peripheral part of the electrode on the fixing member has a recessed shape for releasing the contact between the sliding electrode part and the fixing member as the sliding electrode part moves from the on-position to the off-position.

Moreover, a device including the trigger switch is also within the scope of the technical idea described in the disclosure. In other words, the drive part is driven in a state where the contact between the sliding electrode part and the fixing member is released.

In the trigger switch according to the disclosure, as the sliding electrode part moves from the on-position to the off-position, the contact between the sliding electrode part and the fixing member that fixes the electrode (fixed electrode) is released. As a result, the drive part is prevented from being driven in a state where the sliding electrode part and the fixing member are in contact with each other, and wear of the sliding electrode part can be suppressed.

Hereinafter, embodiments of the disclosure will be described with reference to the drawings.

### [Application Examples]

The trigger switch according to the disclosure is applicable to various electric devices, including electric tools (devices) such as electric drills, electric drivers, electric wrenches, and electric grinders that include a drive part such as a motor.

Moreover, the trigger switch according to the disclosure is configured to release contact between the brush and a fixing member as the brush (a brush that is moveable between an on-position where it contacts an electrode fixed to a fixing member and an off-position where it does not contact the electrode), which serves as a sliding electrode part that constitutes a sliding contact of a circuit provided inside an electric device, moves from an on-position to an off-position. Details will be provided below. In the following, a case will be described in which a substrate is used as an example of the fixing member.

### [Configuration Example]

### (Electric Device PT)

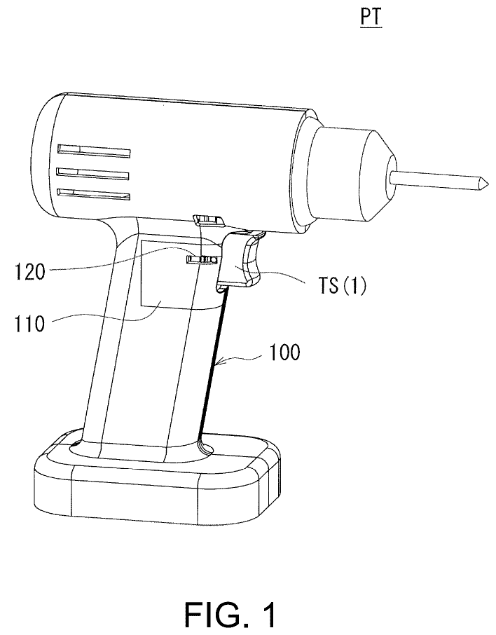

FIG. 1 is a schematic perspective view showing an example of the appearance of an electric device PT according to disclosure. The electric device PT according to disclosure includes a main device 100, and the main device 100 includes a trigger switch TS that receives user's push-in operation. The main device 100 includes a door part 110 that may be opened and closed, and the door part 110 includes a window part 120 through which an attached state of a trigger 1 of the trigger switch TS may be visually confirmed.

The electric device PT shown in FIG. 1 has a shape in which a hand-held part is attached to a substantially cylindrical part. In the following description, the direction of the substantially cylindrical part is referred to as up and the direction of the hand-held part is referred to as down, as shown in the drawings. Moreover, the direction in which the trigger 1 of the trigger switch TS is positioned is referred to as front, and the direction in which the trigger 1 is pushed is referred to as rear. In other words, in the electric device PT and the trigger switch TS, the direction from the front to the rear is the operating direction in which the trigger 1 is pushed by a push-in operation. These directions are for convenience of description and do not limit the directions of use of the electric device PT and the trigger switch TS.

FIG. 1 shows a released state in which the user is not operating the trigger switch TS. From the released state shown in FIG. 1, when a user places his or her finger on the trigger 1 and performs a push-in operation of pushing in the trigger 1 toward the main device 100 (rearward), a drive part (not shown) such as an electric motor built into the main device 100 is driven. The configuration of the sliding contact of the circuit for driving and stopping the drive part and the switching part will be described below.

### (Trigger Switch TS)

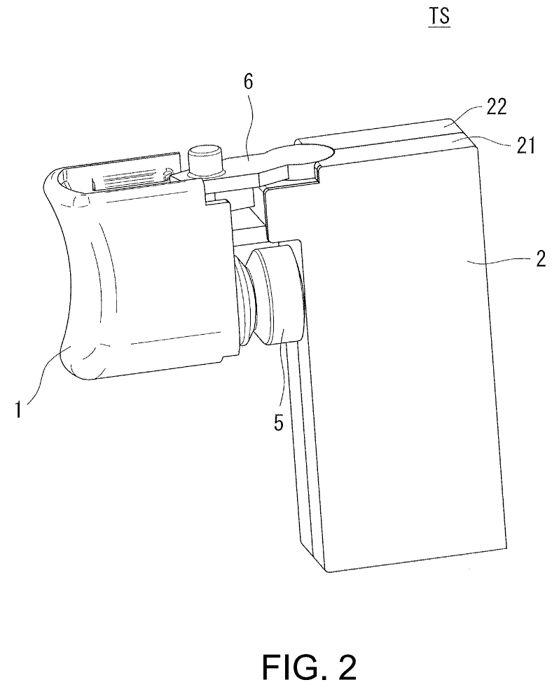

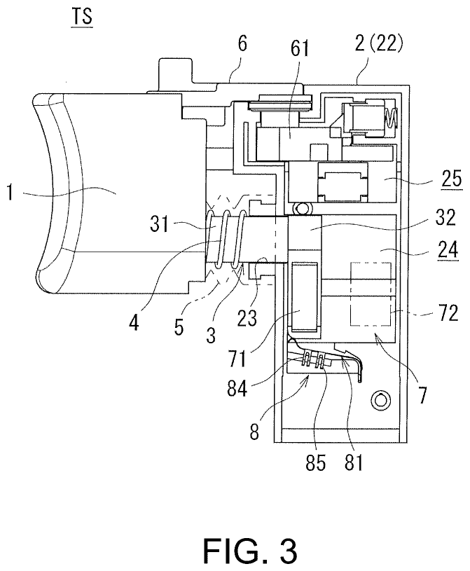

Next, the trigger switch TS provided on the electric device PT will be described. FIG. 2 is a schematic perspective view showing an example of the appearance of the trigger switch TS according to the disclosure. FIG. 2 shows the appearance of the trigger switch TS according to the disclosure as viewed obliquely from above. FIG. 3 is a side view showing an example of the inside of a housing of the trigger switch TS according to the disclosure. In the following description, the direction perpendicular to the paper surface in FIG. 3 is the left-right direction of the switch, the front side of the paper surface is the left side of the switch, and the back side of the paper surface is the right side of the switch. This is also a direction for convenience of description, and does not limit the direction of use of the electric device PT and the trigger switch TS.

The trigger switch TS is a switch operated by a user of the electric device PT, and includes a trigger 1 for the user to perform a push-in operation. The trigger switch TS includes a housing 2 that is incorporated into the electric device PT, a trigger 1, a plunger 3, a restore spring 4 that urges the trigger 1, and a covering member 5. Moreover, the trigger switch TS includes a switching lever 6 for switching the drive direction of the drive part, for example, the forward and reverse direction of rotation of an electric driver.

The trigger 1 is a member that receives a push-in operation by a user. The front surface of the trigger 1 has a shape on which the user places his or her finger during operation. The plunger 3 includes a rod-like shaft part 31 and a drive switching mechanism (moving member) 32 formed continuously with the rear end of the shaft part 31. The trigger 1 is supported at the front end of the shaft part 31. The trigger 1 is fitted into the front end of the shaft part 31 and may be attached to and detached from the front end of the shaft part 31.

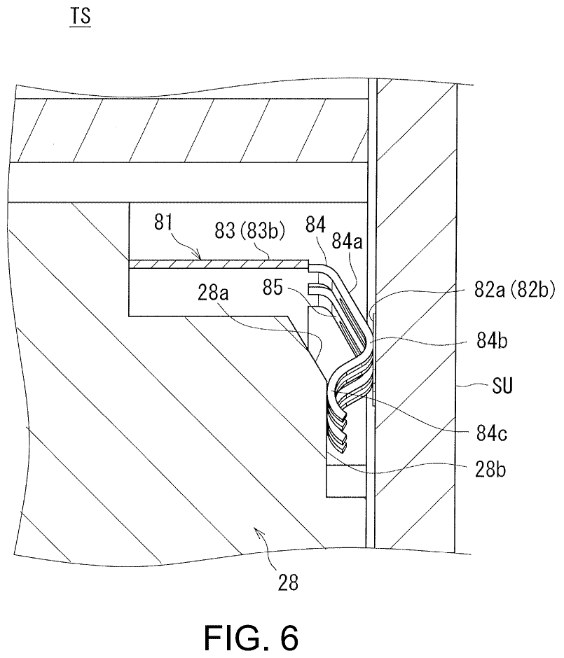

The housing 2 is a hollow case having a substantially rectangular parallelepiped shape, and is configured by integrally assembling a first housing 21 positioned on the left side of the switch and a second housing 22 positioned on the right side of the switch. A drive switching mechanism 32 is accommodated in the internal space of the housing 2 that is composed of the first housing 21 and the second housing 22. Moreover, a substrate (fixing member) SU (see FIG. 6) is attached to the inner surface of the first housing 21 (the surface facing the right side of the switch), and a circuit (not shown) for driving the drive part is arranged on the substrate SU.

On the front surface of the housing 2, there is a substantially circular through hole 23, through which the rear end (the other end side) of the shaft part 31 passes. The periphery of the through hole 23 protrudes forward in a cylindrical shape. The switching lever 6 is attached to the upper surface of the housing 2. The interior of the housing 2 is divided into a lower chamber 24 and an upper chamber 25 in two stages, upper and lower. The drive switching mechanism 32 is accommodated in the lower chamber 24 of the housing 2, and an operation direction switching mechanism 61 is accommodated in the upper chamber 25. The drive switching mechanism 32 is a mechanism that opens and closes a circuit formed on the substrate SU and controls the drive part. The drive switching mechanism 32 moves rear and forth as the shaft part 31 moves. In other words, the drive switching mechanism 32 moves between a push-in position and a push-in release position in accordance with the push-in operation to the trigger 1 and a release of the push-in operation. As shown in FIG. 8 (a schematic side view showing an example when a push-in operation is performed to the trigger 1 of the trigger switch TS according to the disclosure), when the drive switching mechanism 32 moves rearward by a push-in operation to the trigger 1, the drive part operates, and as shown in FIG. 3, when the drive switching mechanism 32 restores to the front, the drive part stops.

The restore spring 4 is formed using a spring such as a compression coil spring. The restore spring 4 winds the shaft part 31 circumferentially on the outside of the housing 2, and urges the shaft part 31 forward, which is the opposite direction to the push-in direction, restoring the shaft part 31 that has been pushed rearward together with the trigger 1, to the forward release position. The front end of the restore spring 4 is locked to the shaft part 31, and the rear end is locked to the periphery of the through hole 23 of the housing 2.

The covering member 5 is formed in a generally cylindrical bellows shape, and covers the shaft part 31 and the restore spring 4 circumferentially outside the housing 2. A front end, which is one end side, of the covering member 5 is attached to the shaft part 31. A rear end, which the other end side, of the covering member 5 is attached so as to cover the protruding part of the periphery of the through hole 23 of the housing 2. The covering member 5 is a packing made of a flexible and airtight material such as rubber, and expands and contracts in the axial direction to seal the inside.

The operation direction switching mechanism 61 is a mechanism that switches the wiring of the circuit opened and closed by the drive switching mechanism 32. The operation direction switching mechanism 61 is attached to the switching lever 6 and operates as the switching lever 6 swings. The operation direction switching mechanism 61 operates to switch the operation direction of the drive part. The switching lever 6 is a member that swings left and right upon receiving a switching operation by a user to switch the drive direction of the drive part, and transmits the swinging operation to the operation direction switching mechanism 61. Moreover, when the switching lever 6 is operated in the middle of its swing range, the switching lever 6 functions as a stopper to prevent push-in operation to the trigger 1.

The trigger switch TS configured as above is incorporated in the electric device PT and receives operation by the user. A user of the electric device PT performs operations such as push-in operation of pushing in the trigger 1 and switching operation of swinging the switching lever 6. The trigger 1 that receives the push-in operation moves rearward. As the trigger 1 moves rearward, the shaft part 31 attached to the trigger 1 also moves rearward. As the shaft part 31 moves rearward, the drive switching mechanism 32 that is continuous with the rear end of the shaft part 31 also moves rearward, and the drive part is driven. Further, as the shaft part 31 moves rearward, the restore spring 4 and the covering member 5 are compressed in the axial direction.

The user releases the push-in of the trigger 1 when stopping the drive part. When the push-in is released, the trigger 1, the shaft part 31 and the drive switching mechanism 32 are moved forward by the urging force of the restore spring 4 and are restored to the release position. Further, as the shaft part 31 moves forward, the restore spring 4 and the covering member 5 extend in the axial direction.

The trigger switch TS includes a switching part 7 having a sensor function that detects the movement (or position) of the trigger 1 when the trigger 1 is pushed in and switching between driving and stopping of the drive part in response to the movement. The switching part 7 includes a switching circuit. The switching circuit is configured using sensors such as optical sensors, magnetic sensors, electrostatic sensors, and electrical resistance sensors that detect the movement (or position) of the trigger 1 non-contactly, and outputs an ON signal or an OFF signal in response to the position of the trigger 1 detected by the sensor. Moreover, the switching circuit may also output an ON signal or an OFF signal in response to contact between a movable contact and a fixed contact caused by the movement (or position) of the trigger 1.

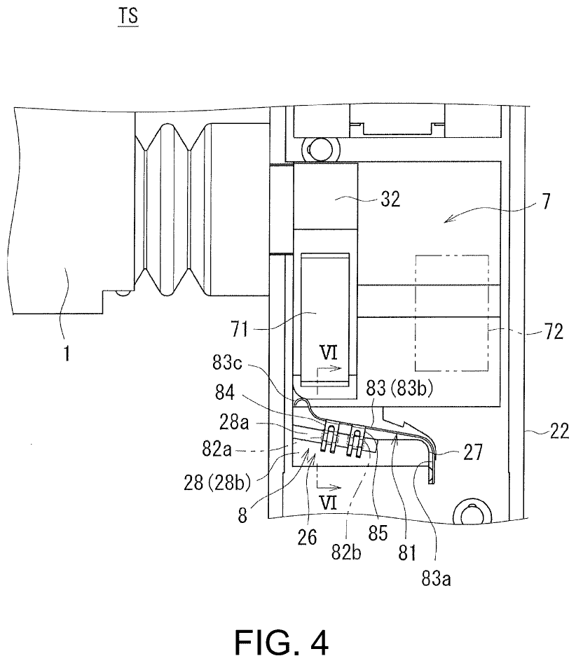

As a specific configuration of the switching part 7, a sensor detection member 71 made of a conductive metal is provided on the surface on the left side of the switch in the drive switching mechanism 32. Moreover, at a rearward position on the substrate SU attached to the inner surface (the surface facing the right side of the switch) of the first housing 21, a detection part 72 (shown by virtual lines in FIGS. 3 and 4) capable of detecting the position of the sensor detection member 71 is formed. In other words, in the released state where no push-in operation is performed to the trigger 1, the sensor detection member 71 is in an off-state at a position away from the detection part 72, the switching circuit for driving the drive part is in an open state, and the drive part is stopped.

From this state, when the shaft part 31 and the drive switching mechanism 32 are moved rearward by the push-in operation to the trigger 1, when the amount of movement reaches a predetermined amount, the sensor detection member 71 is in an on-state at a position overlapping (facing) the detection part 72 (see FIG. 8), and the drive part is driven. Moreover, in the embodiment, the rotation speed of the drive part is increased by sensing the position of the sensor detection member 71, which changes as the push-in operation to the trigger 1 progresses.

Moreover, the trigger switch TS includes a sub-sliding contact 8 for activating a microcomputer (not shown) on the substrate SU. Specifically, the second housing 22 supports a sub-brush 81 that is made by bending a conductive metal. Moreover, on the substrate SU attached to the inner surface of the first housing 21, sub-electrodes 82a and 82b (shown by virtual lines in FIG. 4) that may be contacted by the sub-brush 81 (more specifically, a front sub-brush 84 and a rear sub-brush 85 described below) are formed. In the released state where no push-in operation is performed to the Trigger 1, the sub-brush 81 is in a position overlapping the sub-electrodes 82a and 82b (on-position, which is a position where it contacts the sub-electrodes 82a and 82b), and in this state the microcomputer is in a stopped (sleep) state. The posture of the sub-brush 81 is due to an external force received from the drive switching mechanism 32, as described below.

From this state, when the shaft part 31 and the drive switching mechanism 32 are moved rearward by the push-in operation to the trigger 1, when the amount of movement reaches a predetermined amount, as shown in FIG. 8, the sub-brush 81 is in a position away from the sub-electrodes 82a and 82b (off-position, which is a position where the front sub-brush 84 and the rear sub-brush 85 are not in contact with the sub-electrodes 82a and 82b), and in this state the microcomputer is in an activated (wake up) state. The posture of the sub-brush 81 is due to the release of the external force received from the drive switching mechanism 32, as described below. In the embodiment, as the sub-brush 81 moves upward, it is positioned away from the sub-electrodes 82a and 82b. The configuration for moving the sub-brush 81 upward will be described below. In this way, the sub-sliding contact 8 is configured as an NC contact. In this way, by setting the microcomputer in the sleep state in the released state when no push-in operation is performed to the trigger 1, the power consumption in the released state can be reduced to zero, and the power consumption of the electric device PT as a whole can be reduced.

As a feature of the disclosure, the sub-sliding contact 8 is configured such that, at a stage before the switching part 7 transitions from an off-state (a state in which the sensor detection member 71 does not overlap the detection part 72) to an on-state (a state in which the sensor detection member 71 overlaps the detection part 72), not only contact between the sub-brush 81 and the sub-electrodes 82a and 82b is released, but also contact between the sub-brush 81 and the substrate SU is released (contact between the sub-brush 81 and the resin surface of the substrate SU is released). More specifically, the sub-brush 81 is configured to be deformed in the direction away from the sub-electrodes 82a and 82b (in the direction of retreated from the substrate SU) as it moves from the on-position (position shown in FIG. 4) to the off-position (position shown in FIG. 8), thereby releasing contact with the substrate SU. The configuration of the sub-sliding contact 8 will be described specifically below.

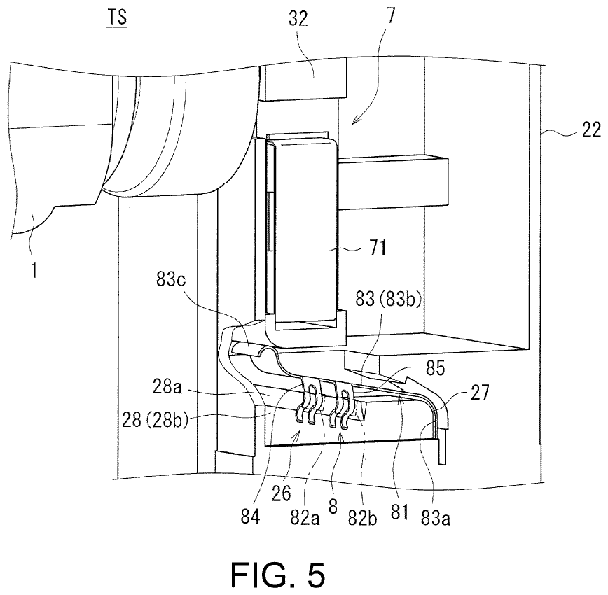

FIG. 4 is a schematic side view showing an example of the trigger switch TS in a released state. FIG. 5 is a schematic perspective view showing an example of the trigger switch TS in a released state. FIG. 6 shows a cross-sectional view along line VI-VI in FIG. 4. FIG. 4 and FIG. 5 show a state where the first housing 21 is removed, and FIG. 6 shows a state where the sub-electrodes 82a and 82b on the substrate SU attached to the inner surface of the first housing 21 are in contact with the sub-brush 81.

As shown in these drawings, the sub-electrodes 82a and 82b are formed at two locations, front and rear, on the substrate SU. Here, the sub-electrode positioned on the front side is referred to as the front sub-electrode 82a, and the sub-electrode positioned on the rear side is referred to as the rear sub-electrode 82b. The sub-electrodes 82a and 82b have a rectangular shape and are disposed at a position slightly lower than the lower end position of the drive switching mechanism 32 and at a predetermined distance in the front-rear direction.

The sub-brush 81 includes an elastic plate part 83 supported by the second housing 22, a front sub-brush (sliding electrode part) 84 integrally formed on the elastic plate part 83 and capable of contacting the front sub-electrode 82a, and a rear sub-brush (sliding electrode part) 85 capable of contacting the rear sub-electrode 82b.

The elastic plate part 83 includes a locking plate part 83a, a main body part 83b, and a pressing plate part 83c.

Further, a sub-brush support part 26 is integrally formed inside the housing 2. The sub-brush support part 26 is configured by partially setting a thickness size of the vertical wall (the vertical wall extending in a direction perpendicular to the left-right direction of the switch) of the second housing 22 to be large, and includes a locking groove 27 and a posture restricting part 28.

The locking groove 27 is provided at approximately the center of the sub-brush support part 26 in the front-rear direction, and its width size in the front-rear direction is set to be equal to a plate thickness size of the locking plate part 83a of the elastic plate part 83 or slightly larger than the plate thickness size of the locking plate part 83a. Moreover, the locking plate part 83a is inserted into the locking groove 27, such that the locking plate part 83a is locked in the locking groove 27.

The posture restricting part 28 is for restricting (restricting to elastically deformed posture) the postures of the front sub-brush 84 and the rear sub-brush 85 of the sub-brush 81. The posture restricting part 28 includes an inclined part 28a that inclines downward toward the left side of the switch, and a vertical part 28b that extends vertically (in a direction perpendicular to the left-right direction of the switch) from the lower end of the inclined part 28a. Restriction of the postures of the front sub-brush 84 and the rear sub-brush 85 by the posture restricting part 28 will be described below.

The main body part 83b of the elastic plate part 83 is continuous with the upper end of the locking plate part 83a and is inclined upward toward the front.

The pressing plate part 83c of the elastic plate part 83 is continuous with the front end of the main body part 83b. The pressing plate part 83c has a curved shape that is convex upward. As shown in FIG. 8, the upper end position of the pressing plate part 83c when no external force is acting on the elastic plate part 83 is set to a position slightly higher than the lower end position of the drive switching mechanism 32 (a position slightly higher than the movement trajectory of the lower end position of the drive switching mechanism 32 when the drive switching mechanism 32 moves). In other words, as shown in FIG. 8, in a state where a push-in operation is performed to the trigger 1, the drive switching mechanism 32 moves rearward, and does not contact the pressing plate part 83c, and no external force is applied to the elastic plate part 83 (pressing plate part 83c). On the other hand, as shown in FIG. 4, when the trigger 1 is in the released state, the drive switching mechanism 32 moves forward, and contacts the upper surface of the pressing plate part 83c, a downward external force acts from the upper surface, pressing down the pressing plate part 83c, such that the main body part 83b is elastically deformed downward, with the rear end position of the main body part 83b (near the boundary with the upper end of the locking plate part 83a) as the swing center. In this state, an upward reaction force is generated in the main body part 83b.

Next, the front sub-brush 84 and the rear sub-brush 85 will be described. The front sub-brush 84 and the rear sub-brush 85 have the same shape. Here, the front sub-brush 84 is described as a representative example. As shown in FIG. 6, the front sub-brush 84 includes an inclined part 84a, an electrode contact part 84b, and a pressing part 84c.

The inclined part 84a is continuous with the end of the left side of the switch of the main body part 83b of the elastic plate part 83, and is inclined downward toward the left side of the switch.

The electrode contact part 84b is a part that contacts the front sub-electrode 82a, is continuous with the lower end of the inclined part 84a, and has a curved shape that is convex toward the left side of the switch.

The pressing part 84c is continuous with the lower end of the electrode contact part 84b and has a curved shape that is convex toward the right side of the switch.

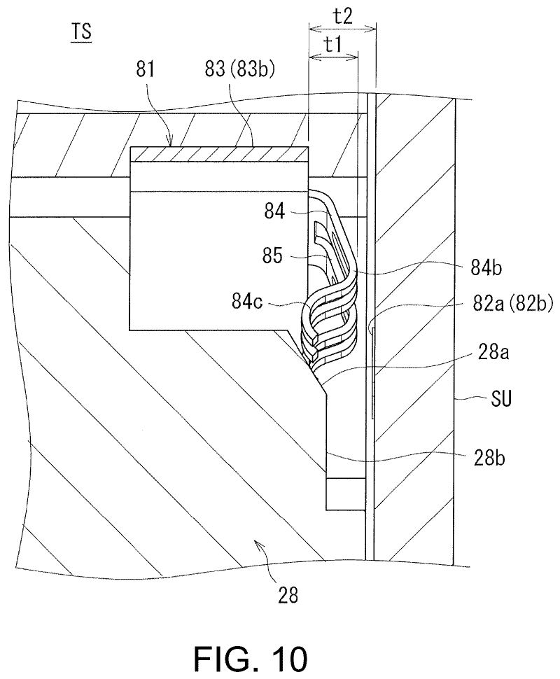

Moreover, when the front sub-brush 84 is in a state where there is no external force (external force toward the left side of the switch: external force directed toward the right side in FIGS. 6 and 10), the distance from the position of the end of the left side of the switch in the main body part 83b to the position of the end of the left side of the switch in the electrode contact part 84b (size t1 in FIG. 10) is set shorter than the distance from the position of the end of the left side of the switch in the main body part 83b to the position of the front sub-electrode 82a by a predetermined size (approximately the same as the distance from the position of the end of the left side of the switch in the main body part 83b to the position of the surface of the substrate SU: size t2 in FIG. 10). In other words, when no external force (external force toward the left side of the switch) is acting on the front sub-brush 84, the electrode contact part 84b is retreated from the substrate SU (away from the substrate SU) and assumes a posture of not contacting the substrate SU.

As described above, the posture restricting part 28 formed inside the housing 2 includes an inclined part 28a and a vertical part 28b. The boundary position between the inclined part 28a and the vertical part 28b is set at a position slightly above the position of the pressing part 84c in the state where the electrode contact part 84b contacts the front sub-electrode 82a (the state shown in FIG. 6). Moreover, the position of the vertical part 28b (position in the left-right direction of the switch) is positioned to the left side of the switch by a predetermined size from the position of the pressing part 84c of the front sub-brush 84 in the state where no external force is acting on the front sub-brush 84 (the state shown in FIG. 10). The predetermined size is set to a size at which the electrode contact part 84b contacts the front sub-electrode 82a when the pressing part 84c of the front sub-brush 84 abuts on the vertical part 28b. Thus, as shown in FIGS. 4 to 6, when the trigger switch TS is in the released state, the drive switching mechanism 32 is in contact with the upper surface of the pressing plate part 83c, such that the pressing plate part 83c of the elastic plate part 83 is pressed down. Accordingly, the front sub-brush 84 moves downward, and the pressing part 84c abuts on the vertical part 28b of the posture restricting part 28 and is elastically deformed to the left side of the switch (elastically deformed toward the front sub-electrode 82a) by receiving a pressing force from the vertical part 28b, and is in contact (pressed) with the front sub-electrode 82a.

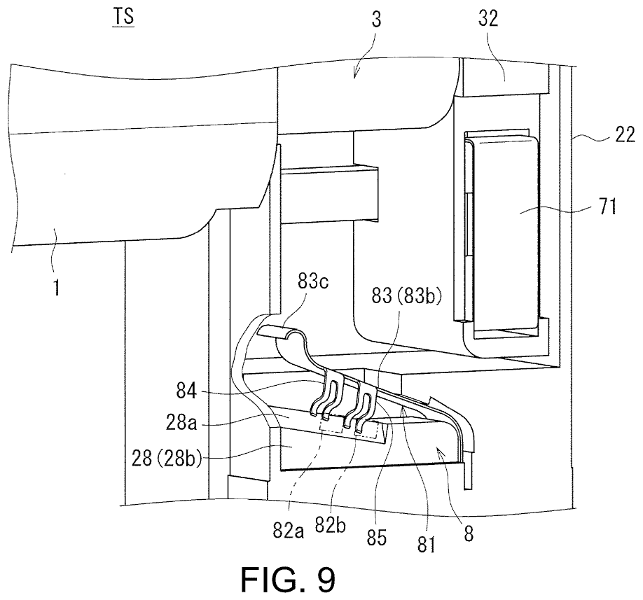

On the other hand, as shown in FIGS. 8 to 10, in a state where a push-in operation is performed to the trigger switch TS, the drive switching mechanism 32 is released from contact with the upper surface of the pressing plate part 83c, and the elastic plate part 83 restores to its original shape. Accordingly, the front sub-brush 84 moves upward, and the pressing part 84c moves from a position abutting on the vertical part 28b of the posture restricting part 28 to a position not abutting on the vertical part 28b (for example, a position abutting on the inclined part 28a or a position floating above the inclined part 28a) and is deformed to the right side of the switch (restoring its shape) and assumes a posture retreated from the substrate SU (a posture away from the substrate SU) by the release of the pressing force from the vertical part 28b.

Moreover, the rear sub-brush 85 has the same configuration as the front sub-brush 84, and when the trigger switch TS is in the released state, it is elastically deformed to the left side of the switch (elastically deformed in the direction toward the rear sub-electrode 82b) and contacts (pressed against) the rear sub-electrode 82b, and when the trigger switch TS is in state where a push-in operation is performed, it assumes a posture retreated from the substrate SU.

### (Control Configuration)

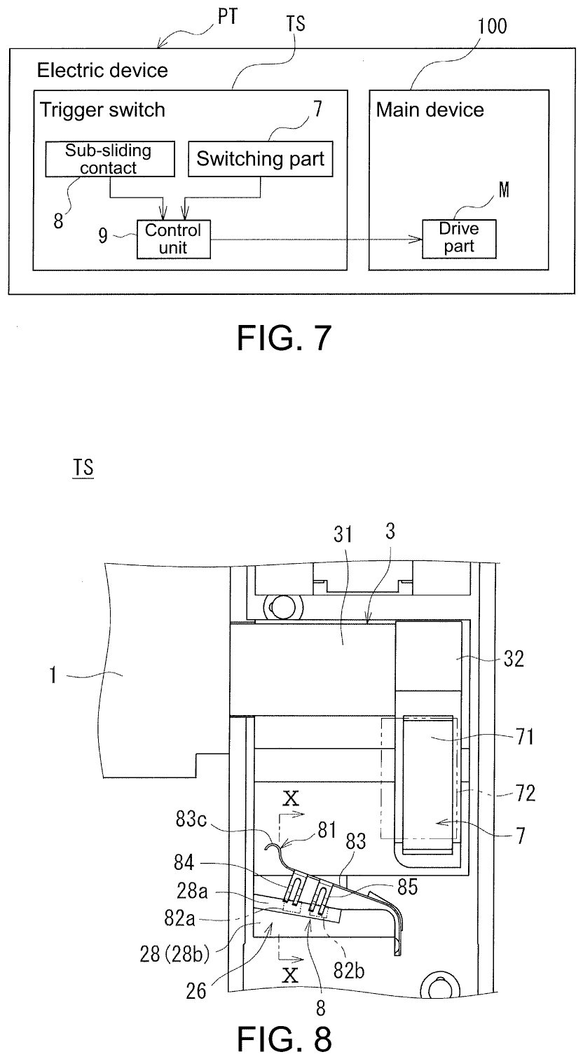

Next, a control configuration of the electric device PT according to the disclosure will be described. FIG. 7 is a schematic block diagram showing an example of a part of a control configuration of the electric device PT according to the disclosure. As shown in FIG. 7, the electric device PT is configured such that the main device 100 and the trigger switch TS may transmit and receive signals. The main device 100 includes a drive part M such as a motor. The trigger switch TS includes a control unit 9 that outputs a drive signal to the main device 100 in response to signals from the switching part 7 and the sub-sliding contact 8.

The control unit 9 of the trigger switch TS is a circuit configured using, for example, a microcomputer using various integrated circuits such as LSI and VLSI, electronic elements, and various terminals, and is disposed on the substrate SU inside the housing 2. The control unit 9 receives signals from the switching part 7 and the sub-sliding contact 8 as inputs, executes various processings based on the inputs, and outputs a drive signal to the main device 100 to drive the drive part M such as a motor provided in the main device 100 of the electric device PT. The electric device PT drives the drive part M based on a drive signal input to the main device 100.

In the embodiment, as the push-in operation to the trigger 1 progresses, a signal (OFF signal) is transmitted from the sub-sliding contact 8, and then a signal (ON signal) is transmitted from the switching part 7. In other words, at a stage before the switching part 7 (the switching circuit of the switching part 7) transitions from the off-state to the on-state as the push-in operation to the trigger 1 progresses, an OFF signal is output from the sub-sliding contact 8, and the contact between the front sub-brush 84 and the rear sub-brush 85 and the substrate SU is released.

### (Push-In Operation to Trigger)

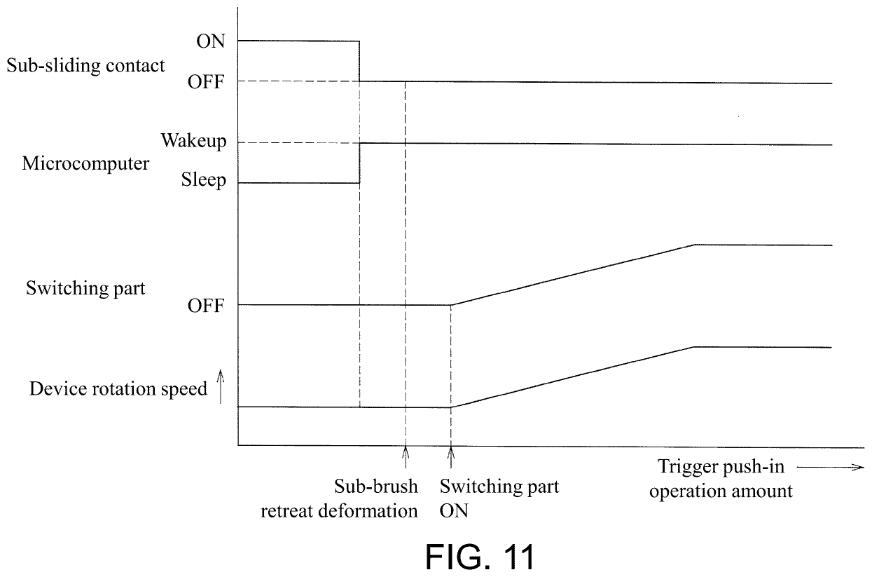

Next, the state of the sub-sliding contact 8 and the switching part 7, the state of the microcomputer, and the change in the device rotation speed when a push-in operation is performed to the trigger will be described. FIG. 11 is a time chart showing an example of changes in the signals of the sub-sliding contact 8 and the switching part 7, the state of the microcomputer, and the device rotation speed when a push-in operation is performed to the trigger 1 in the electric device PT according to the disclosure.

As shown in FIGS. 4 to 6, when the trigger switch TS is in a released state, the sub-sliding contact 8 is in an on-state (a state in which the front sub-brush 84 and the rear sub-brush 85 are in the on-position). In other words, as the drive switching mechanism 32 moves forward, it contacts with the upper surface of the pressing plate part 83c, a downward external force acts from the upper surface, pressing down the pressing plate part 83c, such that the main body part 83b is elastically deformed downward, with the rear end position of the main body part 83b as the swing center. In this state, the pressing part 84c of each of the sub-brushes 84 and 85 abuts on the vertical part 28b of the posture restricting part 28, and is elastically deformed to the left side of the switch (elastically deformed in the direction toward each of the sub-electrodes 82a and 82b) by receiving a pressing force from the vertical part 28b, and each of the sub-brushes 84 and 85 is in contact with each of the sub-electrodes 82a and 82b, respectively. In other words, the sub-sliding contact 8 is in the on-state. In this state, the microcomputer is in a stopped (sleep) state. Moreover, the switching part 7 is in the off-state (the sensor detection member 71 is in the off-position), and the drive part M is stopped.

When the push-in operation to the trigger 1 is started from this state, the plunger 3 moves rearward in accordance with the push-in operation, as shown in FIGS. 8 to 10. As the plunger 3 moves rearward, when the drive switching mechanism 32 is released from contact with the upper surface of the pressing plate part 83c, the elastic plate part 83 of the sub-brush 81 restores to its original shape, and accordingly, the sub-brushes 84 and 85 move upward and the contact with the sub-electrodes 82a and 82b is released. Accordingly, the pressing part 84c of the sub-brushes 84 and 85 move above the vertical part 28b of the posture restricting part 28, and the pressing force from the vertical part 28b is released. In other words, each of the sub-brushes 84 and 85 also restores to its original shape and is deformed so as to retreat from the substrate SU (timing of “sub-brush retreat deformation” in FIG. 11), and contact with the substrate SU is released (see FIG. 10).

After that, when the push-in operation to the trigger 1 is continued and the plunger 3 moves further rearward, and the sensor detection member 71 is in an on-state at a position overlapping with the detection part 72 (see FIG. 8), and the circuit for driving the drive part M is closed, and driving of the drive part M is started (the timing of “switching part ON” in FIG. 11). Moreover, as the push-in operation to the trigger 1 progresses, the signal from the switching part 7 changes, and the rotation speed of the drive part M increases accordingly. In this way, at the time when the driving of the drive part M is started, since each of the sub-brushes 84 and 85 is deformed so as to retreat from the substrate SU, even if vibrations due to the driving of the drive part M are transmitted to each of the sub-brushes 84 and 85 or the substrate SU, the sub-brushes 84 and 85 and the substrate SU do not slide.

### Effects of the Embodiment

As described above, in the trigger switch TS of the embodiment, the contact between each of the sub-brushes 84 and 85 and the substrate SU is released as each of the sub-brushes 84 and 85 constituting the sub-sliding contact 8 moves from the on-position to the off-position. As a result, it is possible to avoid that the drive part M is driven in a state where the sub-brushes 84 and 85 are in contact with the substrate SU, thereby suppressing wear of the sub-brushes 84 and 85, and good contact reliability can be maintained when the sub-brushes 84 and 85 are brought into contact with the sub-electrodes 82a and 82b. Moreover, since wear of the resin surface of the substrate SU can be suppressed, resin powder due to wear is less likely to be generated, thus it is possible to maintain good contact reliability when the sub-brushes 84 and 85 are brought into contact with the sub-electrodes 82a and 82b.

In the trigger switch TS of the embodiment, at a stage before the switching part 7 transitions from the off-state to the on-state as the push-in operation to the trigger 1 progresses, the contact between the sub-brushes 84 and 85 and the substrate SU is released. Thus, it is possible to reliably avoid that the drive part M is driven in a state where each of the sub-brushes 84 and 85 are in contact with the substrate SU, and wear of the sub-brushes 84 and 85 can be reliably suppressed.

### Modified Example

In the embodiment described above, each of the sub-brushes 84 and 85 is released from contact with the substrate SU by restoring its shape from an elastically deformed posture. In other words, the sub-brushes 84 and 85 are retreated from the substrate SU to release the contact between the sub-brushes 84 and 85 and the substrate SU. In the modified example, the substrate SU is improved to release contact between the sub-brushes 84 and 85 and the substrate SU.

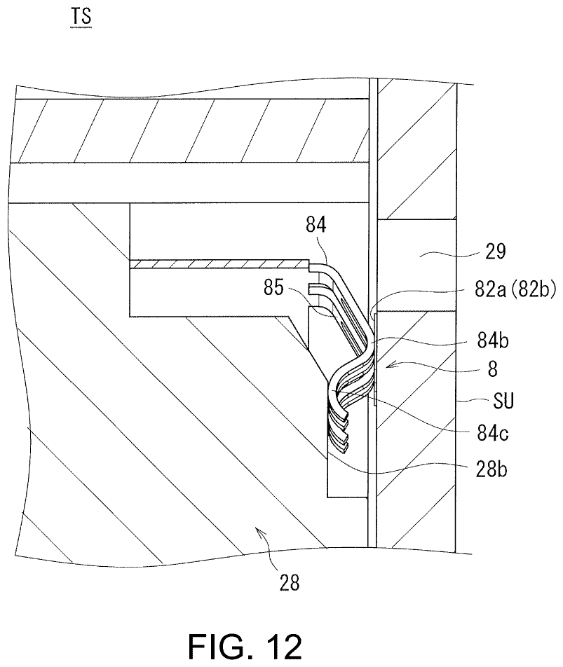

FIG. 12 is a schematic perspective view showing an example of the position of each of the sub-brushes 84 and 85 of the sub-sliding contact 8 when the trigger switch TS in a modified example of the trigger switch TS according to the disclosure is in a released state. As shown in FIG. 12, in the substrate SU of the modified example, an opening 29 is formed above each of the sub-electrodes 82a and 82b. The opening 29 is designed to have a shape in which the sub-brushes 84 and 85 do not contact the substrate SU when the sub-brushes 84 and 85 are moved to the off-position. In other words, when each of the sub-brushes 84 and 85 is moved to the off-position, the electrode contact part 84b of each of the sub-brushes 84 and 85 faces the opening 29 and thus does not contact the substrate SU. That is, the peripheral parts of each of the sub-electrodes 82a and 82b on the substrate SU have a recessed shape that releases contact between each of the sub-brushes 84 and 85 and the substrate SU as each of the sub-brushes 84 and 85 moves from the on-position to the off-position.

In the modified example, there is no need to elastically deform each of the sub-brushes 84 and 85 when the sub-brushes 84 and 85 are in the on-position as shown in FIG. 12. In other words, since there is no need to retreat the sub-brushes 84 and 85 from the substrate SU when a push-in operation is performed to the trigger 1, when the pressing part 84c abuts on the vertical part 28b of the posture restricting part 28, there is no need to elastically deform the sub-brushes 84 and 85 to the left side of the switch (elastically deform in the direction toward the front sub-electrode 82a). Thus, the design of each of the sub-brushes 84 and 85 is easy.

### Other Embodiments

The disclosure is not limited to the above-described embodiments and modified examples, and may be embodied in various other forms. Thus, the above-described embodiment and modified examples are merely illustrative in all respects and should not be construed as limiting. The technical scope of the disclosure is defined by the claims and is not limited in any way by the text of the specification. Further, all modifications and variations within the scope of the claims are within the scope of the disclosure.

For example, in the above embodiments and modified examples, the case where the disclosure is applied to the electric device PT has been described as an example, but the disclosure may also be applied to devices such as water guns, paint guns, and model guns.

Further, in the above embodiments and modified example, the drive switching mechanism 32 provided with the sensor detection member 71 is used to elastically deform the sub-brush 81, but the disclosure is not limited thereto. In other words, any moving member may be configured as long as it is movable between the push-in position and the push-in release position when the push-in operation is performed to the trigger 1 and the push-in operation is released.

Further, in the above embodiments and modified example, the sub-brush 81 has a configuration in which the elastic plate part 83 and the sub-brushes 84 and 85 are integrally formed, but the disclosure is not limited thereto. In other words, the elastic plate part 83 and the sub-brushes 84 and 85 may be formed separately, such that the sub-brush 81 is made up of a plurality of components.

Further, the embodiments and other matters disclosed in this specification may also be understood as the technical ideas described in the following Supplementary Notes.

### (Supplementary Note 1)

A trigger switch including: a sliding electrode part that, when a drive part is driven by a movement of a trigger caused by a push-in operation to the trigger, moves from an on-position where it contacts a fixed electrode to an off-position where it does not contact the electrode. As the sliding electrode part moves from the on-position to the off-position, a contact between the sliding electrode part and a fixing member that fixes the electrode is released.

### (Supplementary Note 2)

The trigger switch according to Supplementary Note 1, including: a switching circuit that transitions from an off-state to an on-state as the push-in operation to the trigger progresses so as to drive the drive part. At a stage before the switching circuit transitions from the off-state to the on-state as the push-in operation progresses, the contact between the sliding electrode part and the fixing member is released.

### (Supplementary Note 3)

The trigger switch according to Supplementary Note 1 or 2, wherein as the sliding electrode part moves from the on-position to the off-position, it is deformed in a direction away from the electrode, releasing the contact with the fixing member.

### (Supplementary Note 4)

The trigger switch according to Supplementary Note 3, including: a posture restricting part that, in a state where the sliding electrode part is in the on-position, restricts the sliding electrode part to a posture elastically deformed in a direction of contacting the electrode. When the sliding electrode part is in the off-position, restriction of the posture by the posture restricting part is released and the sliding electrode part restores its shape from the elastically deformed posture, releasing the contact with the fixing member.

### (Supplementary Note 5)

The trigger switch according to Supplementary Note 4, including: a moving member that is movable between a push-in position and a push-in release position in accordance with the push-in operation to the trigger and a release of the push-in operation; and an elastic plate part configured such that it receives an external force from the moving member in a state where the moving member is in the push-in release position and assumes an elastically deformed posture, and restores its shape from the posture elastically deformed by the external force due to the external force being released by the moving member moving from the push-in release position toward the push-in position. In a state where the elastic plate part assumes the elastically deformed posture, the sliding electrode part is in the on-position where it contacts the electrode by being restricted in posture by the posture restricting part, and in a state where the elastic plate part has restored to the shape, the restriction of the posture by the posture restricting part is released and the contact with the fixing member is released.

### (Supplementary Note 6)

The trigger switch according to Supplementary Note 1 or 2, wherein in the fixing member, an opening is formed in a region facing the sliding electrode part in the off-position.

### (Supplementary Note 7)

The trigger switch according to Supplementary Note 1 or 2, wherein a peripheral part of the electrode on the fixing member has a recessed shape for releasing the contact between the sliding electrode part and the fixing member as the sliding electrode part moves from the on-position to the off-position.

### (Supplementary Note 8)

A device including: the trigger switch according to any one of Supplementary Notes 1 to 7, wherein the drive part is driven in a state in which the contact between the sliding electrode part and the fixing member is released.

What is claimed is:

1. A trigger switch, comprising:
a sliding electrode part that, when a drive part is driven by a movement of a trigger caused by a push-in operation to the trigger, moves from an on-position where it contacts a fixed electrode to an off-position where it does not contact the electrode,
wherein, as the sliding electrode part moves from the on-position to the off-position, a contact between the sliding electrode part and a fixing member that fixes the electrode is released.

2. The trigger switch according to claim 1, comprising:
a switching circuit that transitions from an off-state to an on-state as the push-in operation to the trigger progresses so as to drive the drive part,
wherein, at a stage before the switching circuit transitions from the off-state to the on-state as the push-in operation progresses, the contact between the sliding electrode part and the fixing member is released.

3. The trigger switch according to claim 1,
wherein as the sliding electrode part moves from the on-position to the off-position, it is deformed in a direction away from the electrode, releasing the contact with the fixing member.

4. The trigger switch according to claim 2,
wherein as the sliding electrode part moves from the on-position to the off-position, it is deformed in a direction away from the electrode, releasing the contact with the fixing member.

5. The trigger switch according to claim 3, comprising:
a posture restricting part that, in a state where the sliding electrode part is in the on-position, restricts the sliding electrode part to a posture elastically deformed in a direction of contacting the electrode,
wherein when the sliding electrode part is in the off-position, restriction of the posture by the posture restricting part is released and the sliding electrode part restores its shape from the elastically deformed posture, releasing the contact with the fixing member.

6. The trigger switch according to claim 4, comprising:
a posture restricting part that, in a state where the sliding electrode part is in the on-position, restricts the sliding electrode part to a posture elastically deformed in a direction of contacting the electrode,
wherein when the sliding electrode part is in the off-position, restriction of the posture by the posture restricting part is released and the sliding electrode part restores its shape from the elastically deformed posture, releasing the contact with the fixing member.

7. The trigger switch according to claim 5, comprising:
a moving member that is movable between a push-in position and a push-in release position in accordance with the push-in operation to the trigger and a release of the push-in operation; and
an elastic plate part configured such that it receives an external force from the moving member in a state where the moving member is in the push-in release position and assumes an elastically deformed posture, and restores its shape from the posture elastically deformed by the external force due to the external force being released by the moving member moving from the push-in release position toward the push-in position,
wherein, in a state where the elastic plate part assumes the elastically deformed posture, the sliding electrode part is in the on-position where it contacts the electrode by being restricted in posture by the posture restricting part, and in a state where the elastic plate part has restored to the shape, the restriction of the posture by the posture restricting part is released and the contact with the fixing member is released.

8. The trigger switch according to claim 6, comprising:
a moving member that is movable between a push-in position and a push-in release position in accordance with the push-in operation to the trigger and a release of the push-in operation; and
an elastic plate part configured such that it receives an external force from the moving member in a state where the moving member is in the push-in release position and assumes an elastically deformed posture, and restores its shape from the posture elastically deformed by the external force due to the external force being released by the moving member moving from the push-in release position toward the push-in position,
wherein, in a state where the elastic plate part assumes the elastically deformed posture, the sliding electrode part is in the on-position where it contacts the electrode by being restricted in posture by the posture restricting part, and in a state where the elastic plate part has restored to the shape, the restriction of the posture by the posture restricting part is released and the contact with the fixing member is released.

9. The trigger switch according to claim 1,
wherein in the fixing member, an opening is formed in a region facing the sliding electrode part in the off-position.

10. The trigger switch according to claim 2,
wherein in the fixing member, an opening is formed in a region facing the sliding electrode part in the off-position.

11. The trigger switch according to claim 1,
wherein a peripheral part of the electrode on the fixing member has a recessed shape for releasing the contact between the sliding electrode part and the fixing member as the sliding electrode part moves from the on-position to the off-position.

12. The trigger switch according to claim 2,
wherein a peripheral part of the electrode on the fixing member has a recessed shape for releasing the contact between the sliding electrode part and the fixing member as the sliding electrode part moves from the on-position to the off-position.

13. A device comprising the trigger switch according to claim 1,
wherein the drive part is driven in a state where the contact between the sliding electrode part and the fixing member is released.

14. A device comprising the trigger switch according to claim 2,
wherein the drive part is driven in a state where the contact between the sliding electrode part and the fixing member is released.
